(19) United States
(12) Patent Application Publication
(10) Pub. No.: US 2019/0208758 A1
(43) Pub. Date: Jul. 11, 2019

(54) Flying Tail Cuff

(71) Applicants: Jason Nicholas Kacoyanis, Natick, MA (US); John Mario Lamberti, Stuart, FL (US)

(72) Inventors: Jason Nicholas Kacoyanis, Natick, MA (US); John Mario Lamberti, Stuart, FL (US)

(21) Appl. No.: 15/862,723

(22) Filed: Jan. 5, 2018

(51) Int. Cl. A01K 97/14

(52) U.S. Cl. CPC A01K 97/14

(57) ABSTRACT

Fishermen use gaffs to spear, hold and land large fish. This is dangerous when done from a boat and always kills the fish. A gaff consists of a u-shaped steel bar (“shank”) with one end attached to a pole and the opposite end containing a sharp point. The invention, similar to existing gaffs, but designed to hold a fish without harming it, has a blunt end, rather than a point. Instead of spearing fish, it uses two steel, spring activated, one-way gates, that span the opening between the sides of the shank. They open and then close when pulled or pushed across the part of the fish's body to which the tail attaches, making it impossible for the fish to pull its tail free from the space between the closed gates and the curve in the bend of the shank. The fish is then held without harm.

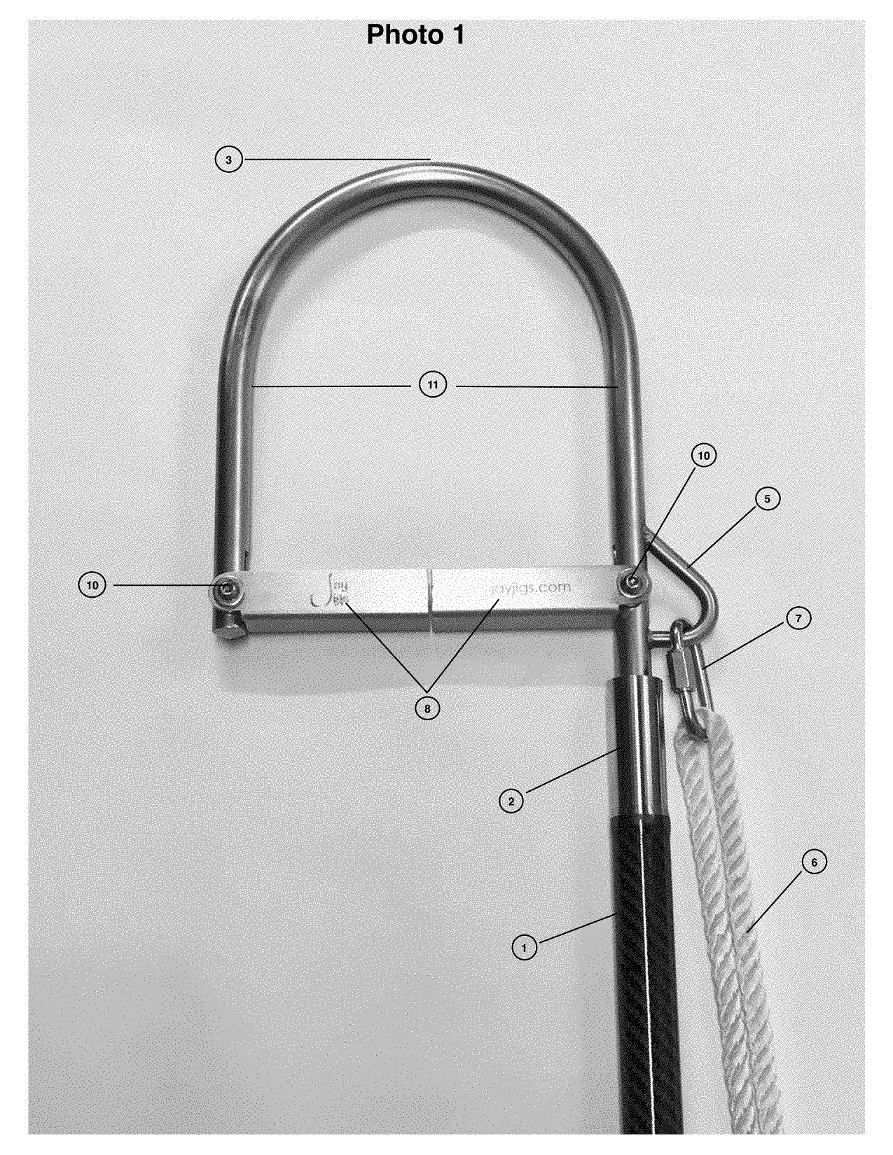

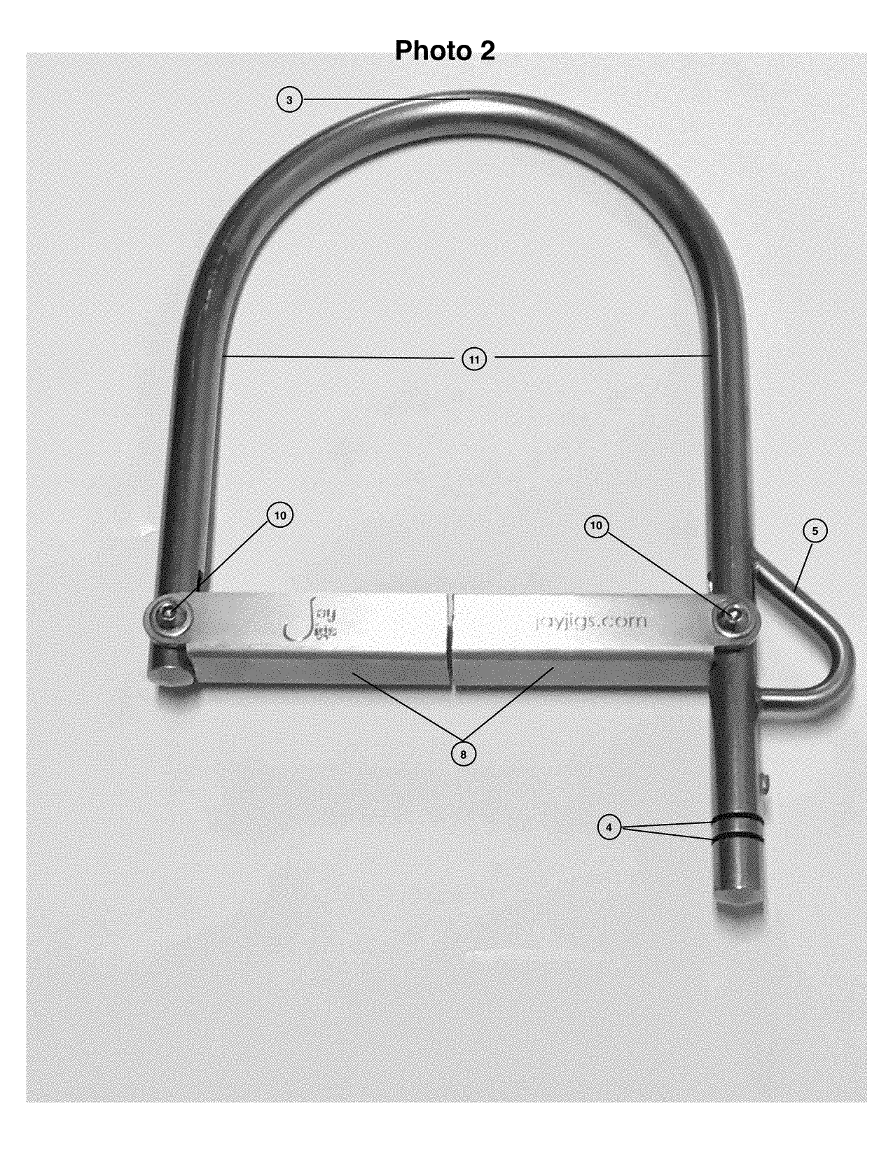

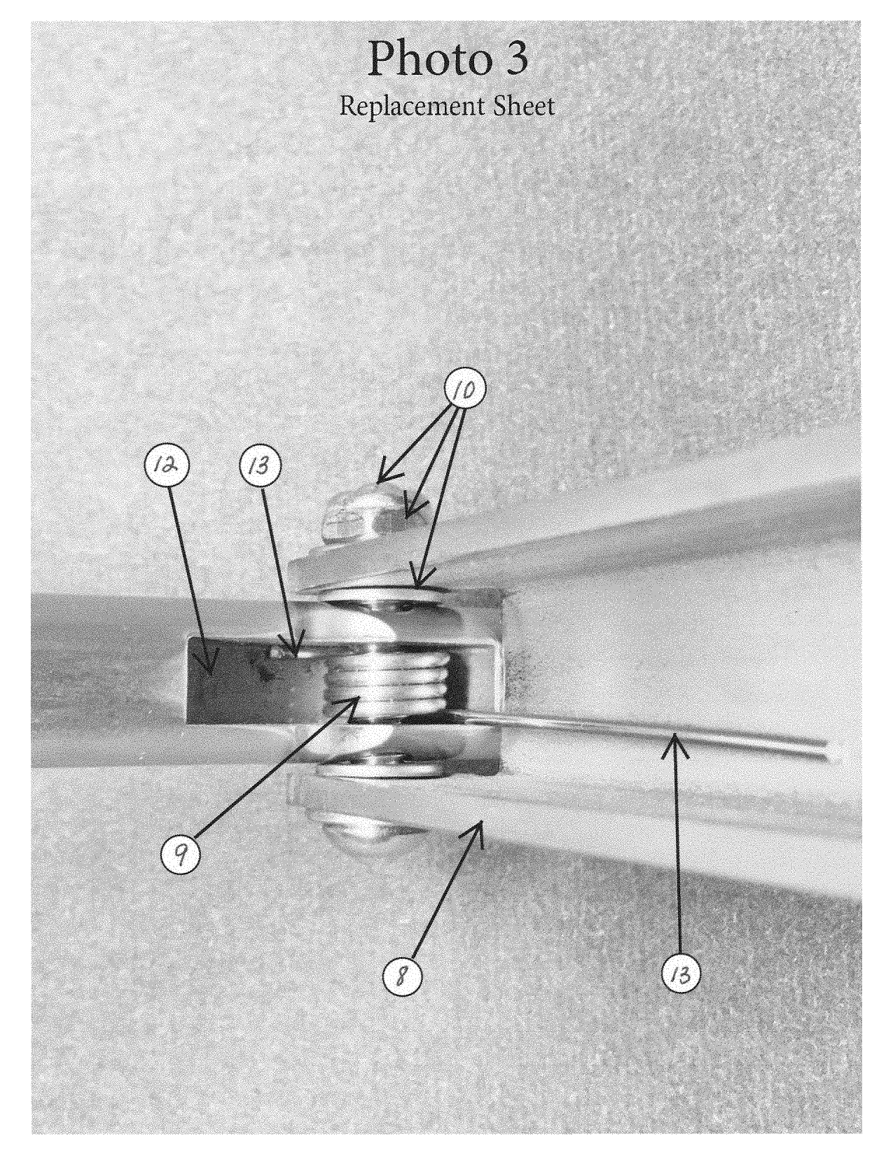

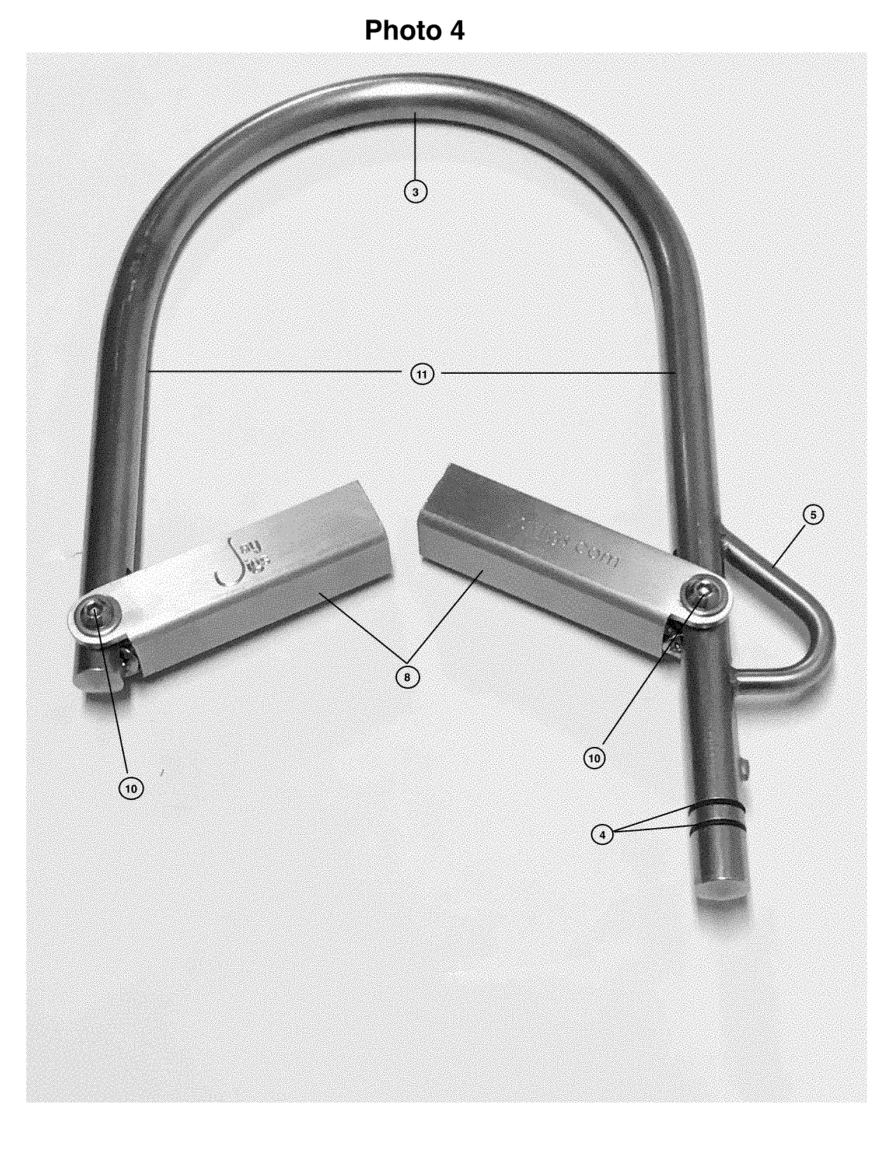

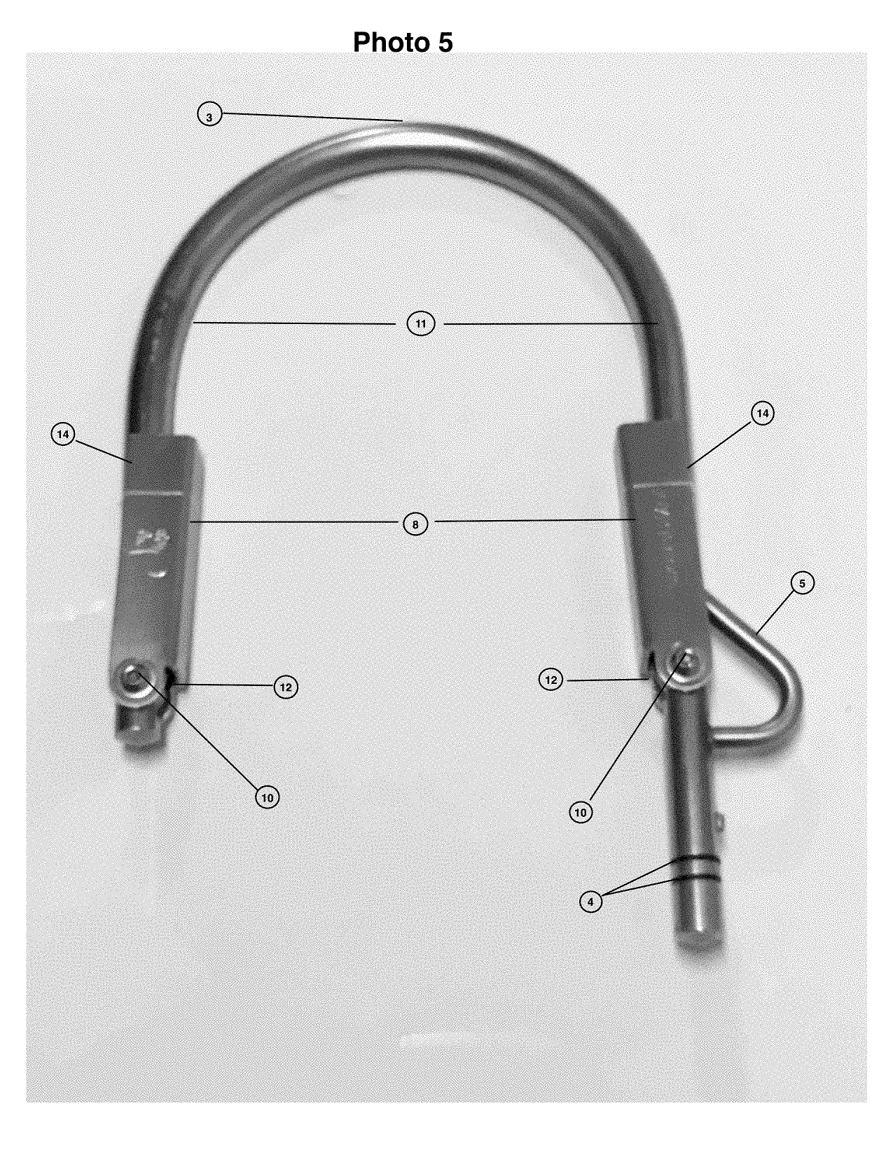

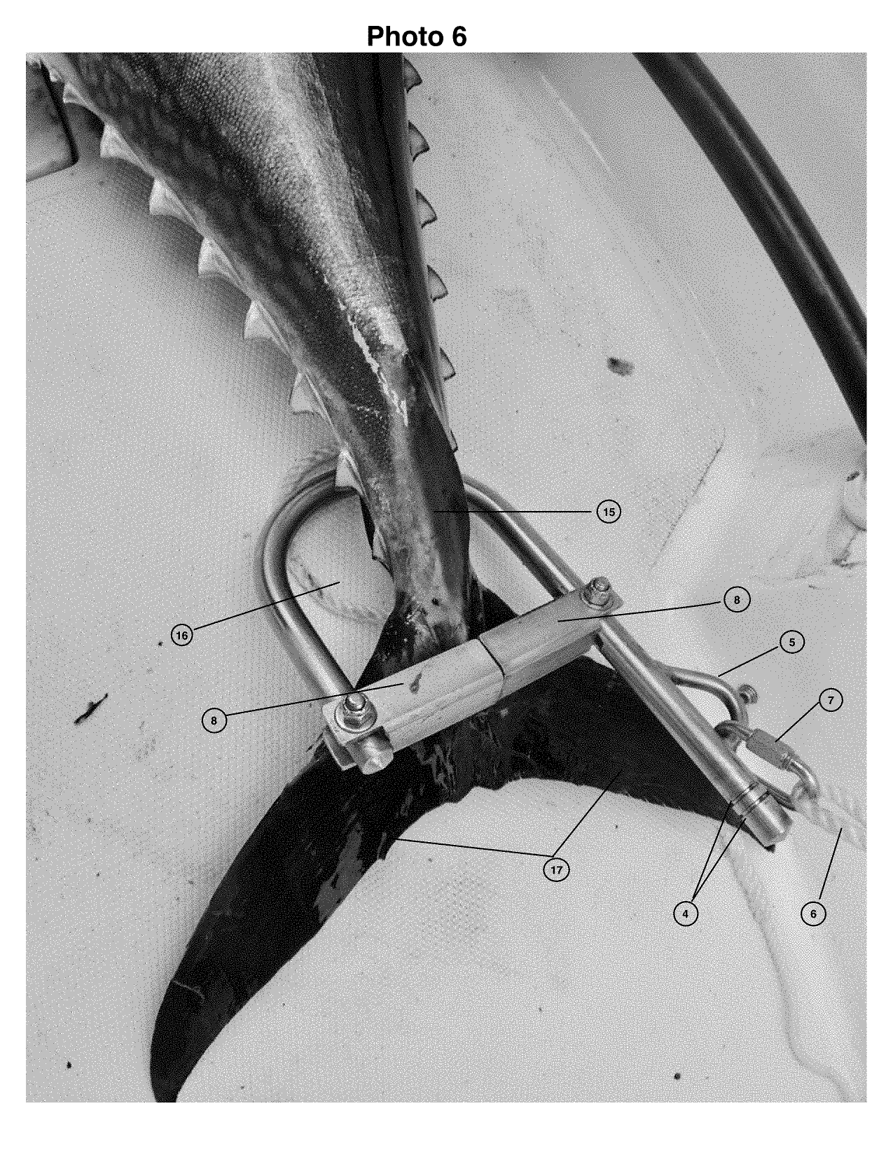

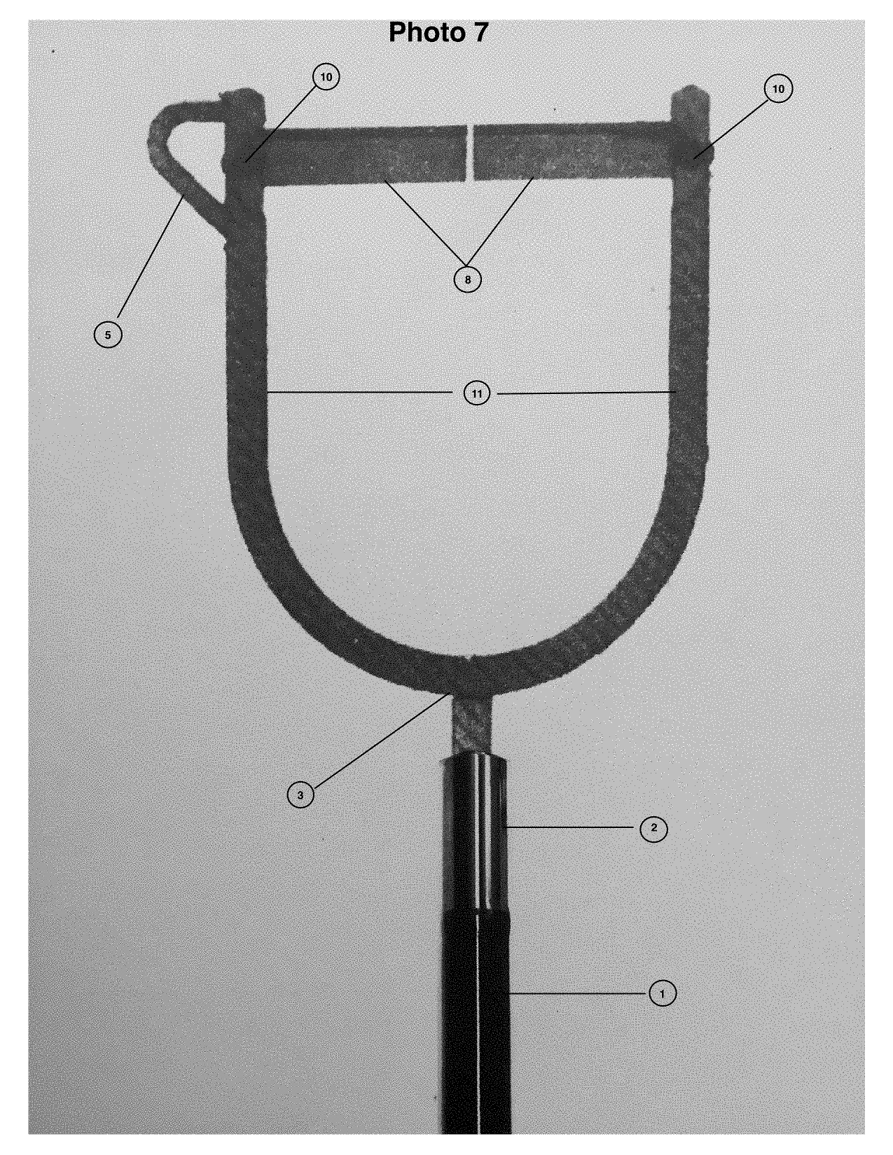

### BACKGROUND OF THE INVENTION

The present invention is in the technical field of fishing gaffs. More particularly, the present invention is in the technical field of flying fishing gaffs.

### SUMMARY OF INVENTION

The present invention relates generally to existing flying gaffs used to stab and subdue large fish.

A gaff is a Pole that has a sharp hook on the end of a U-shaped steel rod that is used to stab a large game fish and then lift the fish into the boat or onto shore. A gaff is essentially a large fish hook that is permanently attached to the end of a long Pole. Like a fish hook, the gaff consists of a steel rod, called a Shank, that is bent in a U-shape so that the Bend causes the bent end of the Shank to parallel the Shank in the opposite direction. This parallel Shank is typically about half the length of the Shank before the Bend. A sharp point is located at the end of the bent section of the Shank. This point is used to stab the fish. As with a fishhook, the entire length of the steel rod is referred to as the “Shank”, the Bend is called the “Bend”, and the point is called the “Point”. The space between the two sides of the bent Shank caused by the Bend is called the “Gap”.

Gaffs are used when the weight of the fish exceeds the breaking point of the fishing line or the fishing Pole. Because of the damage caused to the fish by being stabbed by the point, existing gaffs cannot be used if it is intended to release the fish unharmed after capture.

Gaffs are made in various sizes (diameter and length of Pole and Shank, size of Gap, etc.). Poles are typically made of wood or fiberglass, or various space-age materials and Shanks are made of various grades of steel.

A “flying gaff' is a specialized type of gaff used for securing and controlling very large game fish. The shanks on flying gaffs are not permanently attached to the Pole but fit into an opening on the end of the Pole which is designed to release the Shank when the Shank is pulled upon. On existing flying gaffs, a steel ring is typically welded to the Shank a short distance up from where the Shank is connected to the Pole. A rope is then attached to the ring by a snap hook attached to one end of the rope. The rope is made long enough to ensure that there is sufficient scope to both stab the fish and hold on to it as it tries to escape. To ensure that the rope does not interfere with the crew, the rope is typically run down the length of the Pole and attached to the Pole with attachments such as zip-ties, rubber bands, light tape or a cam cleat. The open end of the rope is then attached to a cleat on the boat. Once a fish has been stabbed by a crewman and pressure is applied to the Shank by either the fish or the crewman, the Shank will pull free (”fly“) from the Pole, the rope will pull free of its attachment to the Pole, and the Shank will remain hooked into the fish. The crewman will then toss the Pole out of the way and grab the rope to secure the fish. Because the end of the rope is attached to a cleat, in the event the crewman loses his grip on the rope the fish will not be able to escape because the rope remains secured to the boat's cleat.

The use of gaffs and flying gaffs to subdue and control large game fish from a boat at sea is the single most dangerous practice in game fishing. Slack ropes, detachable Poles, steel gaff heads, thrashing fish, rough seas and boats moving forward or backward (”backing down“) while fighting a fish can combine to cause serious injury or death to crewmen.

In addition to using gaffs to subdue and capture large game fish, boat crews often try to lasso the fish's tail with a stout rope since the power of a game fish and its ability to escape is primarily in its tail. When brought alongside a boat by a fisherman, the fish's tail is typically thrashing about wildly. If a crewman can place a stout rope over the fish's tail (lasso the tail) the battle is essentially over. Doing so, however, can be extremely difficult and dangerous. To do so a crewman might have to lean over the boat's gunwale, lean down toward the surface of the water, and try to wrap the rope over a thrashing, forked tail that might be over three (3) feet from tip to tip, all while trying to maintain his balance and position in the boat while rough seas and the boat's motion are bouncing him up and down and splashing waves of water against his face and body.

The present invention has been designed to both replace existing flying gaffs when it is the intent of the fisherman to release rather than kill a fish that has been brought to the side of a boat, as well as to provide a safe method of grasping and holding onto the tail of the fish without exposing crewmen to the dangers they presently encounter when lassoing a game fish's tail.

The present invention is designed to permit large game fish, including marlin, swordfish, sharks and tunas to be subdued in a fashion similar to that used by gaffs and flying gaffs, but without causing serious injury to the fish, so the fish can be easily subdued, measured and, if desired, released to swim away and survive. This is known in recreational fishing as “catch and release”.

Catch and release is a practice within recreational fishing intended as a technique of conservation where fish that have been hooked and brought to the side of a boat can be examined, measured, unhooked and returned to the water relatively unharmed. This practice has been growing exponentially in recreational fishing circles all over the world.

The present invention is similar to a flying gaff in that it incorporates: a Pole; a Shank that attaches to and can be pulled free of a Pole; a Bend in the Shank; and a steel ring to which a Rope is attached. It does not, however, contain a point at the end of the Shank which is instead rounded off. In place of a point to stab a fish, the invention uses two steel bars, actuated by Helical Torsion Springs, that are attached to either side of the Shank and across the Gap. These bars act as a one-way double gate that springs open and then closes when pushed or pulled across the narrow part of the fish's body (the caudal peduncle) to which the tail attaches, thereby making it impossible for the fish to pull its forked tail free from the space between the closed gate and the Bend in the Shank.

### Description of Photographic Views of the Invention

Included with this Application are the following 7 Photos, the first 6 of which are of a prototype of the invention and the seventh of which is of a dependent claim of the invention:

PHOTO 1 depicts an overall view of the invention.

PHOTO 2 depicts the upper part of the invention, above the Pole, showing the Shank and Capture Gates in their fully closed position.

PHOTO 3 depicts the machined and drilled section of a Capture Gate, a Helical Torsion Spring, and related hardware in situ.

PHOTO 4 depicts the Capture Gates attached to the Shank in their partially opened position.

PHOTO 5 depicts the Capture Gates attached to the Shank in their fully opened position.

PHOTO 6 depicts a fish's caudal peduncle trapped within the invention's Gap after the invention was used in the described manner.

PHOTO 7 depicts the dependent claim of the invention which has been configured to operate with a pushing motion on the Pole rather than in a pulling motion of the Pole as in the primary invention.

### DESCRIPTION OF THE INVENTION

The present invention has been designed as a tool through which a fisherman can catch, subdue and then release a fish that has been brought to the side of a boat in a way that prevents serious injury or death to both the fish and crewmen on the boat.

The present invention also provides a safe method of grasping and holding onto the tail of a large game fish without exposing crewmen to the dangers they presently encounter when lassoing a game fish's tail.

The invention consists of:

(a) a Pole of from six (6) feet to ten (10) feet in length (No. 1 in Photos 1 and 7);

(b) a round, hollow, steel, Quick Release Snap fitting that is secured to the end of the Pole (No. 2 in Photos 1 and 7);

(c) a steel rod or “Shank” containing a Bend in the Shank that turns the end of the Shank in a one hundred and eighty degree) (180° direction (No. 3 in Photos 1, 2, 4, 5 and 7), the long end of which contains two (2) machined slots into which two O-Rings have been inserted which permit the Shank to be inserted snugly into the Quick Release Snap Fitting and later pulled free by exerting pressure against the Pole. (No. 4 in Photos 2, 4, 5 and);

(d) a Steel Ring, welded to the Shank (No. 5 in Photos 1, 2, 4, 5, 6 and 7), to which a Rope (No. 6 in Photos 1 and 6) is attached by way of a Locking Carabiner or similar clip (No. 7 in Photos 1 and 6);

(e) two (2) steel bars called “Capture Gates” (No. 8 in Photos 1, 2, 4, 5, 6 and 7), actuated by two (2) Helical Torsion Springs (No. 9 in Photo 3), showing a single torsion spring), are bolted to each side of the Shank using common bolts, locknuts and washers (No. 10 in Photos 1, 2, 3, 4, 5 and 7).

The Capture Gates cross the Gap formed by the bent Shank (No. 11 in Photos 1, 2, 4, 5 and 7). At the point where each of the Capture Gates are attached the Shank the Shank has been machined-out and drilled-out to hold each Helical Torsion Spring, as well as the bolts that attach the Capture Gates and the Helical Torsion Springs to the Shank (No. 12 in Photos 3 and 5).

The Helical Torsion Springs (No. 9 in Photo 3) are held in place by the nuts and bolts (No. 10 in Photos 1, 2, 3, 4, 5 and 7). Their action as springs is controlled by positioning one end of each spring against the inside wall of the machined-out Shank and the other end against the inside bottom of the Capture Gates (No. 13 in Photo 3).

The Capture Gates consist of two U-Channel bars that have been machined and positioned on the Shank in such a way as to permit the open sides of each U-Channel bar to fit around the width of the Shank when the Capture Gates are in a fully open position (No. 14 in Photo 5).

The outer end of the bottom of each U-Channel bar has been cut away to a length that permits each capture gate to be bolted to each side of the Shank (No. 12 in Photos 3 and 5), so they are capable of springing open (see partially open gates, No. 8 in Photo 4), but yet stopping in a closed position, when they are perpendicular to and across the Gap when the Capture Gates are in the fully closed position (No. 8 in Photos 1, 2, 6, and 7).

The Capture Gates are designed and bolted in place so as to permit them to spring open toward the Bend in the Shank when the Capture Gates are pulled across the narrow part of the fish's body to which the tail (the caudal peduncle) attaches (No. 15 in Photo 6).

When attempting to capture a fish the crewman positions the invention with the Gap end of the invention just past the fish's caudal peduncle. At the appropriate moment, the Pole is then pulled toward the crewman which causes the caudal peduncle to push open and move past the Capture Gates. Once the caudal peduncle passes the Capture Gates the Helical Torsion Springs on the Capture Gates cause the Capture Gates to spring closed in a position perpendicular to the Gap. As a result, the fish's tail is trapped between the closed Capture Gates and the Bend in the Shank (the “Capture Space”) (No. 16 in Photo 6), making it impossible for the fish to pull its forked tail (No. 17 in Photo 6) free of the invention. The pulling action on the Pole by the crewman, as well as the thrashing of the fish's tail, will cause both the Shank and the rope to pull free from the Pole. The crewman can then throw the Pole aside and grasp the rope to hold onto the fish.

1. A tool designed to capture and secure a large fish without seriously injuring the fish or injury to the fisherman, comprising:
(a) a Pole of varying materials, diameters and lengths;
(b) a round, hollow, steel, Quick Release Snap Fitting that is secured to the end of the Pole;
(c) a steel rod or “Shank” of varying diameters and lengths that attaches to and fits into the opening in the Pole and that has been machined-out and drilled-out to permit two steel bars and Helical Torsion Springs to be strategically attached;
(d) two (2) slots machined into the long end of the Shank into which two (2) O-Rings are inserted to permit the Shank to fit snugly into the Quick Release Snap Fitting on the Pole and then later to be pulled free by exerting pressure against the Pole;
(e) a U-shaped Bend in the Shank that turns the Shank in a one hundred and eighty degree) (180° direction;
(f) a space known as a “Gap” created by the Bend in the Shank;
(g) two (2) steel bars called “Capture Gates”, that can swing open across the Gap in only one direction and that are attached to each side of the Shank with Helical Torsion Spring Clips, nuts, bolts and washers;
(h) two (2) Helical Torsion Springs, bolted within the Capture Gates, one to each side of the Shank, to actuate and control the opening and closing of the gates;
(i) two (2) steel nuts and bolts with steel washers that secure the Capture Gates and Helical Torsion Springs to opposite sides of the Shank;
(j) a Steel Ring to which a Rope is attached;
(k) a Rope attached to the Steel Ring and running along the length of the Pole;
WHEREIN a crewman on a fishing boat can position the invention with the Gap end of the invention just past the narrow part of the fish's body (known as the caudal peduncle) to which the tail attaches and at the appropriate moment pull the Pole toward himself, causing the caudal peduncle to push open and move past the Capture Gates and into the Capture Space (Gap). Once the caudal peduncle passes the Capture Gates the Capture Gates spring closed. The design of the Capture Gates prohibits them from moving in a direction opposite from the direction they swing open, leaving them in a closed position across the Gap. As a result, the fish's tail is trapped in the Capture Space (Gap) formed by the closed Capture Gates and the Bend in the Shank, making it impossible for the fish to pull its forked tail free of the invention. The pulling action on the Pole by the crewman, as well as the thrashing of the fish's tail, will cause both the Shank and the Rope to pull free from the Pole. The crewman can then toss the Pole aside and grasp the Rope to hold onto and subdue the fish in preparation for its release or bringing aboard the boat.

2. The tool as recited in claim 1, including and further comprising:
(a) a Pole of varying materials, diameters and lengths;
(b) a round, hollow, steel, Quick Release Snap fitting that is secured to the end of the Pole;
(c) an opening in the end of the Pole that can both hold and release a steel rod;
(d) a steel rod or “Shank” of varying diameters and lengths containing a U-shaped Bend in the Shank that turns the Shank in a one hundred and eighty degree) (180° direction;
(e) two (2) slots machined into the long end of the Shank into which two (2) O-Rings are inserted to permit the Shank to fit snugly into the Quick Release Snap Fitting on the Pole and then later to be pulled free by exerting pressure against the Pole.
(f) a space known as a “Gap” created by the Bend in the Shank;
(g) two (2) steel bars called “Capture Gates”, that can swing open across the Gap in only one direction and that are attached to each side of the Shank with Helical Torsion Spring Clips, nuts, bolts and washers;
(h) two (2) Helical Torsion Springs, bolted within the Capture Gates, one to each side of the Shank, to actuate and control the opening and closing of the Capture Gates;
(i) two (2) steel nuts, bolts with steel washers that secure the Capture Gates and spring clips to opposite sides of the Shank;
(j) a steel Ring to which a Rope is attached;
(k) a Rope attached to the Steel Ring and running along the length of the Pole;
WHEREIN, rather than one end of the Shank being attached to the Pole as recited in claim 1, a round Steel Bar is welded at the apex of the Bend in the Shank. The end of this Steel Bar is designed and machined so as to fit into the opening in the Pole in the same fashion as recited for the Shank in claim 1, thereby creating a Gap in the Shank whose opening faces away from the Pole rather than toward the Pole as recited in claim 1 (Photo 7). When attempting to capture a fish the crewman positions the invention with the Gap end of the invention in front of the fish's caudal peduncle rather than behind the fish's caudal peduncle as recited in claim 1. At the appropriate moment, the Pole is then pushed away from the crewman, rather than being pulled as recited in claim 1, which causes the caudal peduncle to push open and move past the Capture Gates and into the Capture Space (Gap). Once the caudal peduncle passes the Capture Gates the Capture Gates spring closed. As recited in claim 1, the design of the Capture Gates prohibits them from moving in a direction opposite from the direction they swing open, leaving them in a closed position across the Gap. As a result, the fish's tail is trapped in the Gap formed by the closed Capture Gates and the Bend in the Shank, making it impossible for the fish to pull its forked tail free of the invention. The pull then asserted by the fish trying to escape from the invention causes both the Shank and the Rope to pull free from the Pole. The crewman can then toss the Pole aside and grasp the Rope to hold onto and subdue the fish in preparation for its either release or bring aboard the boat.
